(19) United States
(12) Patent Application Publication
(10) Pub. No.: US 2004/0023008 A1
(43) Pub. Date: Feb. 5, 2004

(54) Security sheet comprising a transparent or translucent layer

(76) Inventor: Henri Rosset, Le Pin (FR)

Correspondence Address: BACON & THOMAS, PLLC, 625 SLATERS LANE, FOURTH FLOOR, ALEXANDRIA, VA, 22314

(21) Appl. No.: 10/363,261

(22) PCT Filed: Sep. 10, 2001
(86) PCT No.: PCT/FR01/02803

(30) Foreign Application Priority Data
Sep. 11, 2000 (FR) 00/11543

(51) Int. Cl. B32B 3/00

(52) U.S. Cl. 428/195.1

(57) ABSTRACT

The invention relates to a coated sheet of security paper which includes security elements and has a high print rendition and a high resistance to circulation, which sheet is characterized in that at least one of its sides is coated with a transparent or translucent coating comprising at least one colloidal silica and at least one transparent or translucent elastomeric binder. In particular, the binder is a polyurethane.

The invention also relates to the process for manufacturing the said sheet and to a banknote obtained from this sheet.

The invention relates to a security sheet that can be used to manufacture security documents, which is printable and has a high print quality, as well as a high resistance to circulation, especially after printing.

The invention relates more particularly to sheets of paper for banknotes or other certificates of value which may especially be printed by offset printing and/or by intaglio printing.

It is known that security documents, for example papers for banknotes or for cheques or for any other certificate of value, include chemical or physical authentication means and/or counterfeiting indicators.

In general, it is known to use, as chemical means, compounds which react with the counterfeiting agents commonly used by counterfeiters. These counterfeiting indicating means react, for example, with acids (hydrochloric acid, citric acid, acetic acid, sulphuric acid, etc.), with bases (especially sodium hydroxide), with oxidizing agents (especially bleach), with reducing agents and with solvents.

It is also known to use physical authentication means which are most often the following:

the absence of optical brighteners fluorescent in the blue-violet when they are exposed to ultraviolet light, these being commonly used in ordinary paper in order to increase its brightness;

the discrete presence of security elements (for example, threads, fibres, planchettes, etc.) which may exhibit variable optical effects, may be coloured or include inscriptions, or may have various physical properties such as magnetism, electrical conductivity, thermomagnetism, etc., and which may lie at least partly within the sheet;

the presence of a watermark, that is to say a controlled modification of the density of the paper fibres in the thickness thereof, this watermark reproducing a given design which is perfectly visible only in transmitted light, that is to say when the paper is held up to the light;

the presence of holograms, moire patterns or other optical effects obtained with optically variable inks deposited on the surface of the sheet;

the rattle of the paper, that is to say a characteristic sound obtained when the paper is given a rapid movement;

the presence of printing on the surface of the paper in the form of patterns or inscriptions of complex colours or shapes which are consequently difficult to reproduce; and

the relief of the printing obtained by the intaglio printing process, this process consisting in etching a plate, in spreading an ink over this plate and in pressing the sheet of paper onto the plate.

European Patent Application EP-A-514 455 describes a security sheet having a high resistance to circulation and good printability, this sheet including a coating made from mineral fillers and an elastomeric binder, particularly a polyurethane. One of the drawbacks of this sheet is that the security elements that it contains, such as the watermark, security thread, flakes or other elements having an especially variable optical effect, are less visible.

The aim of the invention is therefore to provide a sheet intended for the manufacture of security documents, particularly banknotes, which simultaneously has the following properties:

very good visibility of the security elements that the sheet contains;

high print quality ; and

high resistance to circulation, especially after printing, that is to say making the security document obtained from this sheet very durable.

The Applicant, after having tried numerous compositions containing at least one binder and at least one filler, has surprisingly succeeded in solving the problems posed by using a composition containing at least one colloidal silica and at least one transparent or translucent binder of elastomeric nature.

Thus, the invention provides a coated sheet of security paper which includes security elements and has a high print quality and a high resistance to circulation, which sheet is characterized in that at least one of its sides is coated with a transparent or translucent coating comprising at least one colloidal silica and at least one transparent or translucent elastomeric binder.

However, the elastomeric binder may be employed by mixing it with other binders normally used in papermaking, while taking care to ensure that the transparency of the coating is maintained without impairing its level of durability.

Preferably, the elastomeric binder is chosen from the group formed by the polyurethanes that can be used in the form of dispersions stabilized in an aqueous medium (latices).

Preferably, the said polyurethane is chosen from high-hardness polyurethanes; this seems to improve the antiblocking behaviour of the coating when handling the treated sheets.

Preferably, the said colloidal silica is a fumed silica.

Preferably, the silica has a specific surface area, measured according to the BET method (DIN 66 131 standard), of between 300 and 400 m²/g, the BET method giving a measurement of the total specific surface area.

In particular, the said coating according to the invention is characterized in that it comprises:

1 to 95 parts by dry weight of the said silica,

5 to 99 parts by dry weight of the said elastomeric binder,

the sum of the parts of these components making up a total of 100.

Also preferably, the said coating according to the invention is characterized in that it comprises:

30 to 50 parts by dry weight of the said silica,

50 to 70 parts by dry weight of the said elastomeric binder,

the sum of the parts of these components making up a total of 100.

Within this range, it turns out that the coating gives the sheet, and the security document obtained, a particularly high overall resistance to circulation, while still allowing very good print quality. More particularly still, the said coating is characterized in that it comprises approximately 40 parts of the said silica and approximately 60 parts of the said binder, by dry weight, the sum of the parts of these components making up a total of 100, the result obtained appearing to be the optimum for this composition.

Preferably, the sheet according to the invention is characterized in that the said binder is combined with a crosslinking agent, in particular a polyaziridine.

The sheet according to the invention is characterized in that the weight of the coating deposited is between 1 and 15 g/m², preferably between 1 and 10 g/m² per side by dry weight, even more preferably between 2 and 7 g/m² per side by dry weight.

The coating may include other dispersing additives, viscosity modifiers, plasticizers and bacteriostatic agents, for example fungicides. It is not excluded for the coating to include other authentication or anti-counterfeiting agents.

The sheet to be treated according to the invention may be a sheet based on a composition of cellulose fibres and/or cotton fibres and/or synthetic fibres. The sheet may also be a sheet of synthetic material, especially such as the sheets used to make plastic banknotes. This sheet may consist of a single ply or of several plies.

Preferably, the sheet is a paper based on cotton fibres for banknotes and includes a wet-strength agent, especially a melamine-formaldehyde resin or a poly(aminoamide-epichlorohydrin) resin.

The invention also provides a process for manufacturing the said sheet.

The sheet is produced in particular using the process which is characterized in that it comprises the following steps:

a sheet is formed on a papermaking machine which possibly includes a watermarking device, based on a cellulose and/or cotton fibres composition, a wet-strength agent and, optionally, planchettes;

security elements, such as a security thread and/or elements with an optically variable effect, are optionally included in and/or on the sheet;

optionally, the sheet is treated with a sizing agent in a size-press or impregnating press; and

this sheet is then coated with a composition produced in an aqueous medium containing:

the said colloidal silica, used in the form of an aqueous dispersion,

the said elastomeric binder, used in the form of an aqueous dispersion,

where appropriate, a crosslinking agent,

optionally, other additives used in papermaking, and

the sheet is dried at around 100° C.

To deposit the said composition, any coating means standard in papermaking may be used, for example coaters of the gravure, reverse-roll, Champion, “Billblade”, trailing-blade or air-knife type, or a film transfer system of the twin HSM type or an impregnator.

The invention also relates to a banknote obtained from a sheet as described above or obtained according to the process described above.

The following non-limiting examples will more clearly explain how the invention may be put into practice and its advantages.

### EXAMPLE 1

### Comparative Example

The sheet of paper was formed on a papermaking machine called a cylinder mould with a wire which included a pattern allowing a watermark to be produced, this paper possibly being suitable as a paper for manufacturing a banknote, in the following manner:

a cotton fibres pulp was put into suspension in water and this suspension was refined to 60° Schoepper-Riegler;

a wet strength agent was added, namely about 2.5% by dry weight of a poly(aminoamide epichlorohydrin), expressed with respect to the cotton fibres;

iridescent planchettes were also introduced into this suspension;

during formation of the sheet, a microprinted security thread, called a “window thread”, was introduced using known prior techniques so as to make this thread visible in certain windows on the surface of the paper. One method that can be used to introduce this thread is described, for example, in Patent EP 59 056;

after having formed the sheet, it was surface-treated in a size press using a sizing agent; and

the sheet was dried at around 100° C.

The characteristics and results of the tests carried out on this sheet are given in Tables 1 to 3.

### EXAMPLE 2

### According to the Invention

A substrate was obtained according to Example 1, which was then coated using an air-knife coater with a composition made in an aqueous medium which comprised:

39 parts by dry weight of a polyurethane elastomeric binder sold under the name “CROMELASTIC SE871”,

61 parts by dry weight of a fumed colloidal silica sold under the name “Cab-O-Sperse PG002” by the company Cabot,

a polyaziridine crosslinking agent was added in an amount of 3 parts per 100 parts of the above components.

The viscosity was adjusted by means of rheology modifiers normally used in the field of printing/writing coatings for paper.

The weight of the coating deposited, by dry weight, was 4 g/m².

This sheet was printed using intaglio printing and was subjected to various tests.

The characteristics and results of these tests are given in Tables 1 to 3.

### EXAMPLE 3

### According to the Invention

Another example as in Example 2 was produced, but the weight of the coating deposited was 6 g/m² by dry weight.

The characteristics and results of these tests are given in Tables 1 and 2.

### EXAMPLE 4

### According to the Invention

A substrate was produced as in Example 2, but with the following amounts of binder and silica:

51 parts by dry weight of a polyurethane elastomeric binder sold under the name “CROMELASTIC SE871”;

49 parts by dry weight of a fumed colloidal silica sold under the name of “Cab-O-Sperse PG002” by the company Cabot.

The characteristics and results of the tests carried out on this sheet are given in Tables 2 to 3.

### EXAMPLE 5

### According to the Invention

A substrate was produced as in Example 2, but with the following amounts of binder and silica:

61 parts by dry weight of a polyurethane elastomeric binder sold under the name “CROMELASTIC SE871”;

39 parts by dry weight of a fumed colloidal silica sold under the name of “Cab-O-Sperse PG002” by the company Cabot.

The characteristics and results of the tests carried out on this sheet are given in Tables 2 to 3.

### EXAMPLE 6

### According to the Invention

A substrate was produced as in Example 2, but with the following amounts of binder and silica:

76 parts by dry weight of a polyurethane elastomeric binder sold under the name “CROMELASTIC SE871”;

24 parts by dry weight of a fumed colloidal silica sold under the name of “Cab-O-Sperse PG002” by the company Cabot.

The characteristics and results of the tests carried out on this sheet are given in Tables 2 to 3.

Tests and Results

The good printability of the sheets manufactured according to the invention was checked by intaglio and offset printing. The very good intaglio print quality was checked by scanning electron microscopy.

Their resistance to circulation after intaglio printing was tested according to the following criteria:

wet crumpling resistance;

wet rub resistance

wet soiling resistance.

Moreover, the visibility of the security elements (planchettes, thread) through the coating was also checked.

The resistance-to-circulation tests with regard to crumpling resistance and rub resistance are described in the article entitled “Wearing quality of experimental currency-type papers”, Journal of Research of the National Bureau of Standards, Volume 36, pages 249 to 268, March 1946.

The results are given in Table 2.

The wash-out resistance of the intaglio-printed specimens was tested in order to simulate passage through a washing machine. This wash-out resistance test was carried out on the printed sheets in the following manner:

A paper specimen was put in a flask containing water and a detergent, and placed on a TURBULA apparatus rotated for 1 hour. The degradation was assessed visually and according to an internal rating scale of 1 (minimum) to 5 (maximum). The results are given in Table 2.

The results were estimated visually [with the naked eye or with a magnifying device (magnifying glass, microscope)] and by comparison.

The wet soiling resistance test was carried out on the printed sheets in the following manner:

Each sheet of the examples was cut into several specimens.

Each specimen was subjected to crumpling in an IGT creasing apparatus. It was then uncreased manually and then put in a hermetically sealed flask together with ceramic beads 20 mm in diameter and a powder containing yellow and brown pigments, carbon black, vermiculite, an artificial sweat composition and a suintin composition.

The flask was placed in a TURBULA apparatus which was rotated for a total time of 15 minutes. In order to simulate the ageing of the specimens, for a given paper, the rate of soiling was measured by determining the brightness according to the ISO 2471 standard (reflectance at 457 nm) and the degree of yellow before soiling and then after a given time. These determinations were made on a specimen of paper after 5 minutes of soiling, these determinations were made on another specimen of the same paper after 10 minutes of soiling and the same determinations were repeated on another specimen after 15 minutes.

The degree of yellow was determined using an ELREPHO 2000 spectrocolorimeter in the CIE system under illuminant D₆₅ (daylight and without UV) and at an angle of observation of 10 degrees.

To assess the result, the differences in brightness or in degree of yellow before and after soiling for a given time were compared. The smaller the difference, the better the resistance. Thus, the average of the differences in both the brightness and the degree of yellow were calculated in order to have a measure of the average soiling resistance. The results are given in Table 3.

It may be seen that the print quality is significantly better in the case of the sheets produced according to the invention.

It may be seen that the overall resistance of the sheet to circulation (see Tables 2 and 3) is markedly better than that of the control. Compared with the other examples made according to the invention, it appears that the optimum overall resistance to circulation occurs in the case of Example 4.

For all the examples according to the invention, the watermark, the iridescent effect of the flakes and the inscriptions on the security thread can be clearly seen through the said coating.

TABLE 1

| | | Compara- | | |
|---|---|---|---|---|
| | | tive | Example | Example |
| | | Example 1 | 2 | 3 |
| Grammage | g/m² | 86.5 | 92.9 | 95.2 |
| Thickness | μm | 104 | 116 | 115 |
| Bulk | cm³/g | 1.20 | 1.25 | 1.21 |
| Bendtsen porosity | cm³/min | 7.85 | <5 | <5 |
| R/V Bekk smoothness | s | 35.6- | 21.0- | 24.6- |
| | | 30.4 | 14.8 | 17.6 |
| Opacity | % | 86.1 | 87.5 | 86.9 |
| (paper backing) | | | | |
| Dry/wet burst | kPa | 459-234 | 452-238 | 464-226 |
| strength | % | 50.1 | 52.7 | 48.7 |
| Wet strength | | | | |
| Ash content | % | 1.87 | 6.12 | 6.93 |

TABLE 2

| | | | Wet rub resistance: | |
|---|---|---|---|---|
| | Wet | | number of to-and-fro | |
| | crumpling | Wash-out | rubs before the start | |
| | resistance | resistance | of visual degradation | |
| | after 16 | after 1 | is observed | |
| | crumplings | hour | WATER | BLEACH |
| Comparative | 4.0 | 3.5 | 150 | <50 |
| Example 1 | | | | |
| Example 2 | 4.5 | 5.0 | 500 | 70 |
| Example 3 | 5.0 | 4.5 | 550 | 60 |
| Example 4 | — | 4.5 | 1000 | 120 |
| Example 5 | — | 4.0 | 1000 | 160 |
| Example 6 | — | 2.5 | 400 | 180 |

TABLE 3

| | | | | | | | | Average |
|---|---|---|---|---|---|---|---|---|
| | | | | | | | | of the |
| | | | | | | | | diff- |
| | | | | | | | | erences |
| | | | | | | | | in |
| | | | | | | | | Brightness |
| | | | | | | | | degree of |
| | time | Before | after | difference | before | after | difference | yellow |
| Example 1 | 5 min | 79.79 | 65.76 | 14.03 | 8.92 | 22.14 | 13.2 | 13.6 |
| | 10 min | 79.82 | 65.32 | 14.50 | 8.85 | 22.43 | 13.6 | 14.0 |
| | 15 min | 79.76 | 66.29 | 13.47 | 9.01 | 21.53 | 12.5 | 13.0 |
| Example 2 | 5 min | 79.2 | 73.3 | 5.9 | 9.67 | 14.46 | 4.79 | 5.35 |
| | 10 min | 79.3 | 71.4 | 7.9 | 9.57 | 16.22 | 6.65 | 7.28 |
| | 15 min | 79.3 | 69.6 | 9.7 | 9.68 | 17.84 | 8.16 | 8.93 |
| Example 4 | 5 min | 79.3 | 72.7 | 6.6 | 9.73 | 15.20 | 5.47 | 6.04 |
| | 10 min | 79.0 | 70.0 | 9.0 | 10.17 | 17.69 | 7.52 | 8.26 |
| | 15 min | 79.2 | 67.1 | 12.1 | 9.96 | 20.26 | 10.3 | 11.2 |
| Example 5 | 5 min | 78.14 | 73.52 | 4.62 | 10.60 | 14.24 | 3.64 | 4.13 |
| | 10 min | 78.20 | 72.01 | 6.19 | 10.70 | 15.19 | 4.49 | 5.34 |
| | 15 min | 78.19 | 71.70 | 6.49 | 10.77 | 15.81 | 5.04 | 5.77 |
| Example 6 | 5 min | 77.78 | 74.02 | 3.76 | 11.12 | 13.94 | 2.82 | 3.29 |
| | 10 min | 77.80 | 72.76 | 5.04 | 10.90 | 14.43 | 3.53 | 4.29 |
| | 15 min | 77.89 | 71.82 | 6.07 | 10.75 | 15.42 | 4.67 | 5.37 |

1. Coated sheet of security paper which includes security elements and has a high print quality and a high resistance to circulation, characterized in that at least one of its sides is coated with a transparent or translucent coating comprising at least one colloidal silica and at least one transparent or translucent elastomeric binder.

2. Sheet according to claim 1, characterized in that the elastomeric binder is chosen from the group formed by polyurethanes that can be used in the form of stabilized aqueous dispersions.

3. Sheet according to either of claims 1 and 2, characterized in that the said polyurethane is chosen from high-hardness polyurethanes.

4. Sheet according to one of the preceding claims, characterized in that the said silica is a fumed silica.

5. Sheet according to one of the preceding claims, characterized in that the said silica has a specific surface area, measured according to the BET method (DIN 66 131 standard), of between 300 and 400 m²/g.

6. Sheet according to one of the preceding claims, characterized in that the coating comprises:
1 to 95 parts by dry weight of the said silica,
5 to 99 parts by dry weight of the said elastomeric binder,
the sum of the parts of these components making up a total of 100.

7. Sheet according to the preceding claim, characterized in that the said coating comprises:
30 to 50 parts by dry weight of the said silica,
50 to 70 parts by dry weight of the said elastomeric binder,
the sum of the parts of these components making up a total of 100.

8. Sheet according to the preceding claim, characterized in that the said coating comprises approximately 40 parts of the said silica and approximately 60 parts of the said binder, by dry weight, the sum of the parts of these components making up a total of 100.

9. Sheet according to one of the preceding claims, characterized in that the said composition includes a crosslinking agent, in particular a polyaziridine.

10. Sheet according to one of the preceding claims, characterized in that the weight of the coating deposited is between 1 and 15 g/m², preferably between 1 and 10 g/m² per side by dry weight, even more preferably between 2 and 7 g/m² per side.

11. Process for manufacturing a sheet according to one of the preceding claims, characterized in that it comprises the following steps:
a sheet is formed on a papermaking machine which possibly includes a watermarking device, based on a cellulose and/or cotton fibres composition, a wet-strength agent and, optionally, planchettes;
security elements, such as a security thread and/or elements with an optically variable effect, are optionally included in and/or on the sheet;
optionally, the sheet is treated with a sizing agent in a size-press or impregnating press; and
this sheet is then coated with a composition produced in an aqueous medium containing:
the said colloidal silica, used in the form of an aqueous dispersion,
the said elastomeric binder, used in the form of an aqueous dispersion,
where appropriate, a crosslinking agent,
optionally, other additives used in papermaking, and
the sheet is dried at around 100° C.

12. Banknote obtained from a sheet according to one of claims 1 to 10 or obtained according to claim 11.
